(19) United States
(12) Patent Application Publication
(10) Pub. No.: US 2004/0007913 A1
(43) Pub. Date: Jan. 15, 2004

(54) Road vehicle braking system

(76) Inventor: Roger Erwin, Peabody, MA (US)

Correspondence Address: Paul J. Cook, 94 Central Street, Topsfield, MA, 01983, US

(21) Appl. No.: 10/191,860

(22) Filed: Jul. 10, 2002

(51) Int. Cl. B60T 13/00

(52) U.S. Cl. 303/7

(57) ABSTRACT

A brake system is provided for a towing road vehicle attached to a towed road vehicle. An electric switch in the towing vehicle is electrically connected to one or more electrical pumps in the towed vehicle which are capable of increasing hydraulic pressure in the hydraulic brake system of the towed vehicle.

### BACKGROUND OF THE INVENTION

This invention relates to a means of actuating the brake system of a towed vehicle, such as an automobile or a truck by utilizing the towed vehicles own brake system in conjunction with the towing vehicle's brake system. The invention permits the use of a towed vehicles brake system while in tow, as well as in an emergency when the towed vehicle unexpectedly becomes separated from the tow vehicle.

### BACKGROUND OF THE INVENTION

In some states with the United States, the law requires than any vehicle in tow must have a brake actuation system that actuates when the towing vehicles towing brakes are actuated. Also, in the event of a separation of the towed vehicle from the towing vehicle, the brakes need to be actuated by a break away device that will apply the towed vehicle's brakes. There are limitations to the braking systems currently used.

At the present time a proportionate braking system is available from Roadmaster, Inc., a firm located at 5602 N.E. Skyport Way, Portland, Oreg., 907218 which consists of an air cylinder designed to actuate a towed vehicle's brake pedal. This brake system is in use in conjunction with motor homes towing vehicles, especially light cars. The air cylinder is actuated from air tapped off the air or air over hydraulic brake system of a motor home that include air or air over hydraulic brake systems. For motor homes that do not have an air system, a compressor is required to be added. A problem with an air system is moisture in the air, especially in wintertime. A problem with an air cylinder actuating a towed vehicle's brake pedal is that, while a vehicle is being towed, the vehicle's vacuum power boost system is off. This condition requires excessive brake pedal force to compensate for the lack of vacuum boost that would be available if the towed vehicle was being driven instead of towed. This excessive brake pedal force, as it is repeated enough times, wears out the mechanical linkages, connections, and structure of the brake pedal and the surrounding structure of the vehicle to which the brake pedal is mounted. Typically, the surrounding structure is the firewall of the vehicle, which is not designed to withstand repetitive excessive force applications on the brake pedal attached to the firewall.

There is also available a braking system which uses vacuum from an engine of a towing vehicle in conjunction with a double acting vacuum cylinder with two three-way electric solenoid operated vacuum valves to pull on a brake cable. The cable, in turn pulls on an attachment to the towed vehicle's brake pedal as the towing vehicle brake pedal is actuated. As vacuum is not available form a diesel engine, the applicability of this system is restricted to towing vehicles with gasoline powered engines. Also, there are problems resulting from cable stretch, cable fraying, and fitting connections to the cable. Also, in this system the vacuum is used to retract the vacuum cylinder's piston to pull on the brake cable. Retracting a vacuum cylinder's piston to exert a force, or move a load, for example, a one and a half inch diameter vacuum, with a single one half inch rod is about 11% less efficient in retracting a load, as opposed to being used to extend a load. In the event of a towed vehicle breaking loose from a towing vehicle, the system actuates automatically. A limitation to this approach is that for many smaller cars, there is insufficient space under the hood of the car for the vacuum cylinder. Also, the brake cable passes through the firewall of the towed vehicle to a bracket attached to the towed vehicle's brake pedal. When the towed vehicle is driven, there is a problem of what to do with the pedal bracket and cable. A loose cable end and the bracket on the floor of the vehicle is apt to interfere with a driver's foot while the driver is trying to actuate a pedal. Also, to ensure sufficient vacuum for stopping the towed vehicle in the event of a breakaway condition, an optional vacuum reservoir is available that usually will not fit in the engine compartment of small cars. The system uses vacuum derived from a towing vehicle engine creating the possibility of contamination entering the towing vehicle engine which could cause engine wear and failure.

Both of the above systems rely on hoses from the towing vehicle to the towed vehicle which involves a hose the length of the towing vehicle as well as two quick disconnects in the hoses between the vehicles. The hose between the two vehicles runs a risk of hose damage from road hazards. Three quick disconnects are required. For vacuum systems, dirt can enter the equipment on the towing vehicle. For hydraulic hoses, leakage which means a loss of fluid can result. For air systems, air pressure can be lost, which can cause a serious problem with the towing vehicle brake system.

U.S. Pat. No. 6,158,823 discloses a vacuum operated brake actuation system for actuating a towed vehicle's brake system. Its preferred embodiment comprises a source of vacuum, an electrically operated, spring return, four way, two position vacuum valve with flow controls, and a double acting vacuum operated cylinder that actuates the towed vehicle's brake pedal which actuates the towed vehicle's brake system as directed by said valve. It also comprises electrical wiring, vacuum hoses, fittings, connections, check valves, a breakaway switch, a cable from the towing vehicle to the breakaway switch, and other miscellaneous bracketry as required to complete the system. In the preferred embodiment, a vacuum pump along with a vacuum level sensor and switch for monitoring vacuum levels and passing electrical power to operate the vacuum pump is installed in the towed vehicle as a source of vacuum. A less desirable approach would be using the towing vehicle as the source of vacuum.

U.S. Pat. No. 6,296,323 discloses a braking system for a towed vehicle which includes a pump for increasing hydraulic pressure in a hydraulic brake system of a towed vehicle hydraulic braking system. The hydraulic interconnection to the hydraulic braking system of the towed vehicle includes at least one valve that insures desired pressure with the braking system of the towed vehicle. Such an automatic valving arrangement is particularly required when the pump utilized is an impeller pump. The use of automatic valves between the towed vehicle hydraulic braking system and the pump is particularly undesirable since automatic valves are subject to failure which can lead to catastrophic results when it is desired to bring the towed vehicle to a stop.

Existing systems typically use a three way air or vacuum valve for cylinder rod actuation in a given direction and rely on brake system return springs for return of the pedal with attachments. This can cause brake drag in some circumstances. In addition, existing systems do not provide a means for utilizing the hydraulic braking system of the towed vehicle in a controlled variable manner whenever the hydraulic braking process in the towed vehicle can be accurately controlled. In addition, it would be desirable to eliminate automatic valves or other means that regulate pressure for controlling flow of hydraulic fluid between a towed vehicle brake system and a means for controlling pressure in the towed vehicle hydraulic braking system. This elimination of automatic valves would eliminate a source of catastrophic failure of the towed vehicle braking system.

### SUMMARY OF THE INVENTION

The present invention is based upon the discovery that an electronically controlled gear pump for controlling the hydraulic pressure within a hydraulic braking system of a towed vehicle eliminates the need for automatic valves or the like between the hydraulic braking system of a towed vehicle and a means for controlling the pressure in a hydraulic system of a towed vehicle. The present invention comprises an electronically controlled pump system for a towing vehicle and for a towed vehicle that actuates the towed vehicle's own brake system through the use of a gear pump controlled by varied electronic input from an electronic brake controller mounted into the towing vehicle. The preferred embodiment comprises electronic gear pump(s) that vary in speed to produce a varied pressure with a varied input voltage. The inclusion of the system of this invention in no way effects the intended use or operation of the towed vehicle's brake system and further, once installed, is blind to the operator, i.e., there are no bulky rods, pumps, or devices that need to be installed/removed each time the operator wishes to drive the vehicle or tow it behind a towing vehicle such as a motor home. Further, the output of the gear pump(s) is controlled directly by the output voltage of a brake controller in the towing vehicle which acquires its signal from the towing vehicles reduction in inertia generated by the towing vehicle stopping, resulting in a perfectly linear stopping of both vehicles. When the brake pedal in the towing vehicle is released, the voltage to the pumps is canceled resulting in an immediate release of the towed vehicles own brake system. In a preferred embodiment, the electric motor(s) that operate the gear pump(s) are equipped with thermal limit switches that will inactivate the gear pump(s) if the temperature of the motor reaches a predetermined limit. This feature will prevent the overheating & use of the motors in the event of “stop and go” traffic where there is little need for additional braking.

### BRIEF DESCRIPTION OF THE DRAWINGS

FIG. 1a is a schematic view of a brake control which is utilized in the braking system of this invention.

FIG. 1b is a partial view of a decelerometer useful in the present invention.

FIG. 2 is a schematic view of a braking system of this invention.

FIG. 3 is a side view of a manifold utilized in the system of FIG. 2.

FIG. 4 is a schematic view of an alternative braking system of this invention.

### DESCRIPTION OF SPECIFIC EMBODIMENTS

The braking system of this invention for a towing vehicle and a towed vehicle both of which have a hydraulic braking system is operated by a driver of the towing vehicle. A switch is provided in the towing vehicle which is connected both to a source of electrical power in the towing vehicle and to one or two electrically powered gear pumps in the towed vehicle that are capable of activating the hydraulic braking system in the towed vehicle. The power switch can be operated manually or it can be activated automatically with a device such as an ammeter or decelerometer that senses change in inertia of the towing vehicle so as to control electrical power to the gear pump for activating the hydraulic braking system of the towed vehicle. In any event, when the powered switch is activated, an electrical current is supplied to the one or more gear pumps which activate the hydraulic braking system of the towed vehicle. After the vehicles have been satisfactorily slowed or stopped, the powered switch is reversed such as by sensing the change in inertia which approaches zero (when the vehicles are stopped) to reduce or stop electrical power from the switch to the towed vehicle. In one embodiment of this invention, a fluid diverter plate is utilized to direct fluid from a brake fluid reservoir to either the master cylinder of the towed vehicle or to the gear pumps. In a second embodiment of this invention, manually operated valves are utilized to direct fluid from a brake fluid reservoir to either the master cylinder of the towed vehicles or to the gear pumps. These manually operated valves function either in an “on” position or in an “off” position and do not regulate pressure in the hydraulic brake system. Pressure in the hydraulic brake system is regulated by the gear pumps. Lines 47 and 48 are in fluid communication with conduit 27. Lines 45 and 49 are in fluid communication with conduit 29.

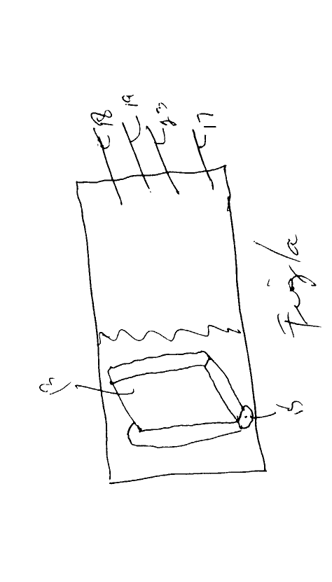

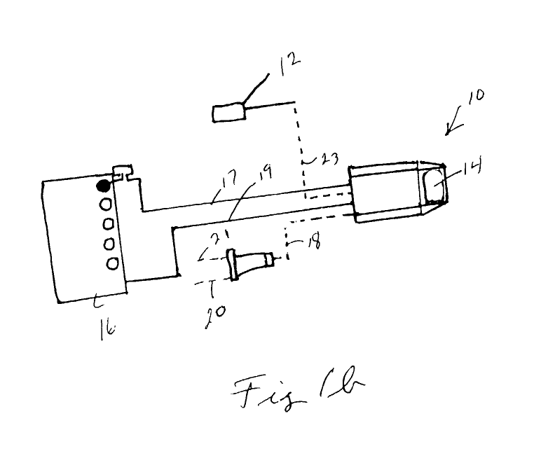

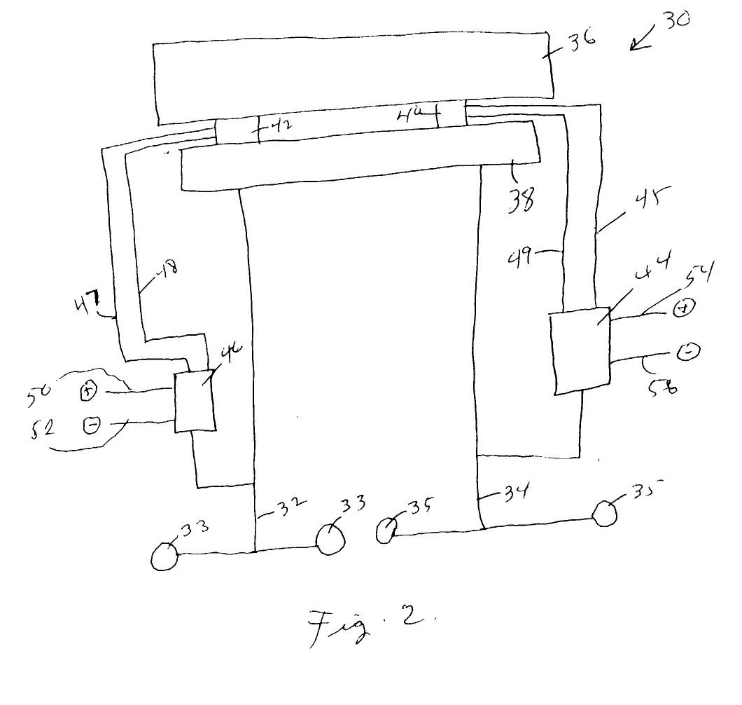

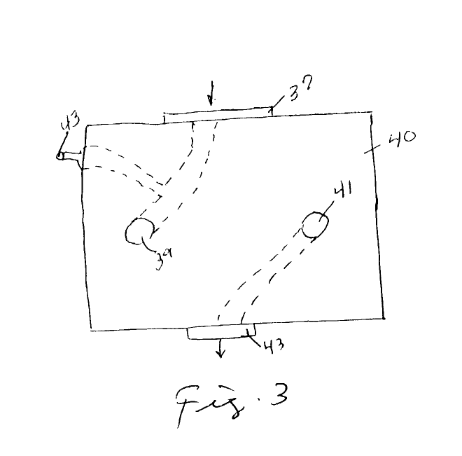

Referring to FIGS. 1a and 1b, the powered switching system includes a switch for a brake light 12 which is connected to ammeter or decelerometer 14 by wire 23. The brake light 12 is connected by wires 17 and 19 to the ammeter or decelerometer 14 which includes a pivotally mounted lever 13 on pivot 15 which is also connected to power source 16 which can be the battery in the towing vehicle. The ammeter or decelerometer 14 also is electrically connected to the towed vehicle through electrical connections 18, 20 and 21. Electrical connections 20 and 21 receive power from battery 16 through ammeter or decelerometer 14 and are connected to one or more electrically powered gear pumps which are capable of activating the hydraulic braking system of the towed vehicle. Lever 15 moves in response to change in inertia caused by activating the brakes of the towing vehicle. The extent of change in inertia of lever 13 controls the electrical power to the gear pumps 44 and 46 (FIG. 2).

Referring to FIG. 2, the braking system 30 which is positioned within the towed vehicle comprises a brake line 32 containing hydraulic fluid for the rear wheels 33 of the towed vehicle and brake line 34 contain hydraulic fluid for the front wheels 35 of the towed vehicle. The braking system 30 includes the conventional components of a vehicle braking system including a reservoir 36 for hydraulic fluid and master cylinder 38 which deliver pressurized hydraulic fluid to the vehicle brakes for both the front wheels 35 and the rear wheels 33. Electrical gear pumps 44 and 46 are connected to an electrical power source in the towing vehicle by electrical leads, 50, 52, 54 and 56. When the powered switch of FIG. 1 is activated, pumps 44 and 46 pump hydraulic fluid from the reservoir 36 to the rear brake line 32 to the rear brakes and to the front brake line 34 to the front brakes of the towed vehicle to effect slowing or stopping wheels 33 and 35. When electric power to the pumps 44 and 46 is shut off, hydraulic fluid is no longer pumped to the brakes of the towed vehicles and the towed vehicle is free to move.

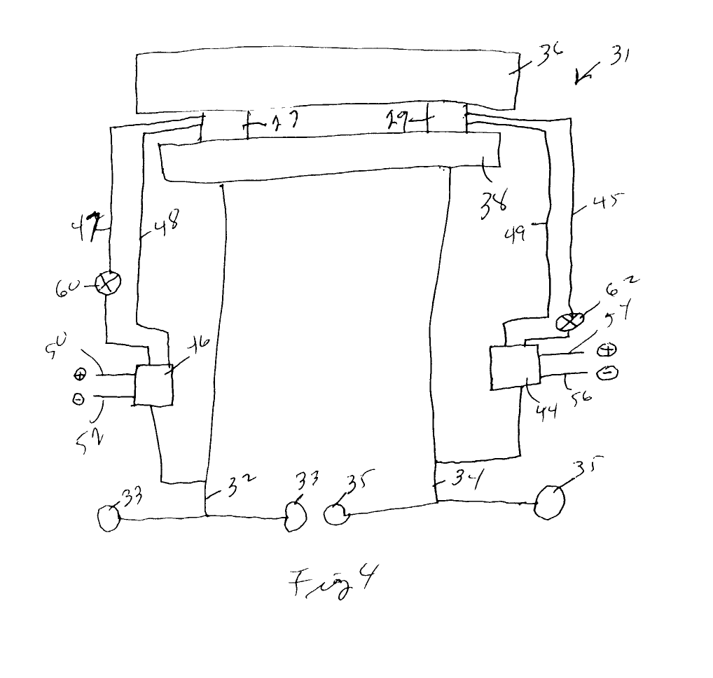

Fluid direction plate 40 and 42 have the same construction (See FIG. 3) and function to deliver brake fluid to master cylinder 38, to electrical gear pump 44 through line 45, and to electrical gear pump 46 through line 47. Return line 48 directs hydraulic fluid to master cylinder 38 from pump 46. Return line 49 directs hydraulic fluid to master cylinder 38 from pump 44.

Referring to FIG. 3, the fluid direction plate 40 which is structured the same as fluid direction plate 42 (FIG. 2) include an inlet 37 which is in fluid communication with reservoir 36 and an outlet 39 which is in fluid communication with pump 40. A second inlet 41 is provided which is in fluid communication with master cylinder 38. A bleed valve 43 is provided to bleed air from the braking system. Fluid direction plate 42 functions in the same manner as manifold 40 but in conjunction with pump 46.

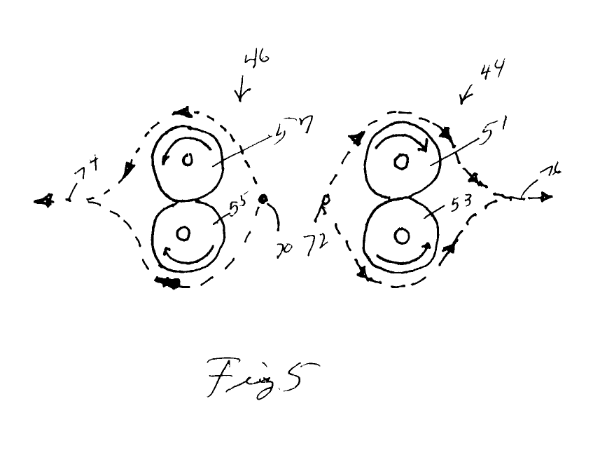

Referring to FIG. 4, the reference numbers which are the same reference numbers in FIG. 2 refer to the same elements as in FIG. 2. The system 31 of FIG. 4 is utilized in vehicles which do not have room to accommodate the fluid direction plate 40 and 42. Conduits 27 and 29 provide fluid communication between reservoir 36 and master cylinder 38. The system 31 utilizes manually activated valve 60 to effect fluid communication between reservoir 36 and pump 46 as well as hand activated valve 62 to effect fluid communication between reservoir 36 and pump 44. The use of manually activated valves that are either in an “on” position or in an “off” position rather than valves that are automatically closed or open in response to an activating agent such as electrical power or pressure provides improved safety since the valves must be properly positioned in the “on” position prior to taking a trip with the vehicle rather than relying on automatic positioning during a trip. Accordingly, the manually operated valves are preferred over automatically activated valves. Once the valves are opened to effect fluid communication between the reservoir 36 and pumps 44 and 46, the system 31 functions in the same manner as system 30 (FIG. 2).

Referring to FIG. 5, pumps 44 and 46 include an inlet 70 in fluid communication with line 45 on an inlet 72 in fluid communication with line 43. Pumps 44 and 46 include two rotating gears 51 and 53 or 55 and 57 which intermesh with each other and discharge a stream of hydraulic fluid 74 or 76 in line 32 or 34 to activate the braking system of the towed vehicle as described above.

1. A braking system for a towed vehicle that is towed by a towing vehicle which comprises:
a first gear pump positioned in said towed vehicle, said first gear pump being in first fluid communication between a reservoir for hydraulic fluid in said towed vehicle and a first braking system for a first set of wheels in said towed vehicle, said first fluid communication being free of a valve,
a second gear pump positioned in said towed vehicle said second gear pump being in second fluid communication between a reservoir for hydraulic fluid in said towed vehicle and a second braking system for a second set of wheels in said towed vehicle, said second fluid communication being free of a valve,
and a control connected to a source of electrical power in said towing vehicle, said control including an electrical power control selected from the group consisting of an ammeter and a decelerometer to regulate electrical power to said first gear pump and to said second gear pump in response to braking force applied to said towing vehicle.

2. A braking system for a towed vehicle that is towed by a towing vehicle which comprises:
a first gear pump positioned in said towed vehicle said first gear pump being in first fluid communication between a reservoir for hydraulic fluid in said towed vehicle and a first braking system for a first set of wheels in said towed vehicle, said first fluid communication including a manually operated valve,
a second gear pump positioned in said towed vehicle said second gear pump being in second fluid communication between a reservoir for hydraulic fluid in said towed vehicle and a second braking system for a second set of wheels in said towed vehicle, said second fluid communication including a manually operated valve,
and a control connected to a source of electrical power in said towing vehicle, control including an electrical power control selected from the group consisting of an ammeter and a decelerometer to regulate electrical power to said first gear pump and to said second gear pump in response to braking force applied to said towing vehicle.

3. A braking system for a towed vehicle that is towed by a towing vehicle which comprises:
a gear pump positioned in said towed vehicle, said gear pump being in fluid communication between a reservoir for hydraulic brake fluid in said towed vehicle and a braking system for a set of wheels in said towed vehicle, said fluid communication being free of a valve,
and a control connected to a source of electrical power in said towing vehicle, said control including an electrical power control selected from the group consisting of an ammeter and a decelerometer to regulate electrical power to said gear pump in response to braking force applied to said towing vehicle.

4. A braking system for a towed vehicle that is towed by a towing vehicle which comprises:
a gear pump positioned in said towed vehicle said gear pump being in fluid communication between a reservoir for hydraulic brake fluid in said towed vehicle and a braking system for a set of wheels in said towed vehicle, said fluid communication including a manually operated valve,
and a control connected to a source of electrical power in said towing vehicle, said control including an electrical power control selected from the group consisting of an ammeter and a decelerometer to regulate electrical power to said gear pump in response to braking force applied to said towing vehicle.
